(19) United States
(12) Patent Application Publication
(10) Pub. No.: US 2009/0059249 A1
(43) Pub. Date: Mar. 5, 2009

(54) IMAGE FORMING APPARATUS, MAINTENANCE MANAGEMENT METHOD THEREOF AND IMAGE FORMING MANAGEMENT SYSTEM

(76) Inventors: Kenji Izumiya, Tokyo (JP); Hiroshi Oyama, Tokyo (JP); Yumiko Higashi, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/951,247

(22) Filed: Dec. 5, 2007

(30) Foreign Application Priority Data
Jul. 12, 2007 (JP) JP2007-183588

(51) Int. Cl. H04N 1/60

(52) U.S. Cl. 358/1.9

(57) ABSTRACT

An image forming apparatus for forming the image based on the image information on the prescribed surface of the transfer material, having an image forming section 8 to form benchmarks for image position identification at prescribed positions on the sheet, benchmark sensors 11 and 12 to detect the position of the benchmarks formed on the sheet and to output position information, a memory section 30 to memorize the position information detected by the mark sensors 11 and 12, and a control section 15 to carry out statistical processing of the position information memorized in the memory section 30 so as to understand tendency and characteristic of displacement amounts of the benchmarks analyzed quantitatively with time.

This application is based on Japanese Patent Application No. 2007-183588 filed on Jul. 12, 2007, in Japanese Patent Office, the entire content of which is hereby incorporated by reference.

### BACKGROUND OF THE INVENTION

The present invention relates to a tandem type color printer and a color complex machine to form an image based on image information on a prescribed surface of an transfer material and to form a mark image for image position identification on the transfer material, an image forming apparatus adaptable for the color complex machine thereof, a maintenance management method and an image forming system.

In recent years, the tandem type color printers and the color complex machines have been becoming popular to be used. According to these kinds of image forming apparatus, to represent R color, G color and B color of a color image, for example, using a writing unit having a specific exposing scanning system, an electrostatic latent image is formed on each photoconductive drum for yellow (Y), magenta (M), cyan (C) and black (BK) colors, thereafter the electrostatic latent image on each photoconductive drum is developed to be a toner image of each color, then each toner image formed on the photoconductive drum of each color is superimposed on an intermediate transfer belt. The color toner image superimposed on the intermediate belt is transferred onto a desired sheet. Then after a fixing process, the sheet is discharged.

Also, in an image forming apparatus having a double-side image forming mode which forms color images on obverse and reverse side of the sheet, when a color image is formed on a obverse side of the sheet, the sheet is turned over through a transfer sheet turning over path and the aforesaid process is carried out again on the reverse side of the sheet to transfer the color image on the reverse side of the sheet. Then after fixing process the sheet is discharged.

Regarding the color printer having such kind of double-side image forming mode, The Patent Document 1 discloses an image forming apparatus and an image forming controlling method. According to the image forming apparatus, bias and skew of the sheet is detected by a contact image sensor (CIS), and when a displacement exceeding a predetermined amount is detected, whether the fed sheet is from a sheet feeding tray or from an automatic sheet conveyance unit (ADU) is judged.

For example, in case the fed sheet causing the displacement exceeding the predetermined amount is from the sheet feeding tray, only the sheet causing the displacement is discharged as an error sheet. Also, if it is a fed sheet from the ADU, all sheets in the ADU are discharged as the error sheets. For an image supposed to be formed on the error sheet, a recovery control is carried out so that the image is formed on other sheets. By configuring the apparatus in this way, a down time due to sheet displacement can be deduced.

Patent Document 1 Tokkai 2003-327345 (page 4, FIG. 1)

Meanwhile, according to the image forming apparatus related to the conventional examples, the following problems exist.

1) According to the image forming apparatus in Patent Document 1, the contact image sensor to detect the sheet position is provided in the apparatus so that in case the displacement of the sheet exceeds the predetermined tolerance, operation is stopped and retry control is executed. However, in case a conveyance direction of the sheet is deviated from a correct direction due to progress of wear of sheet conveyance rollers and the sheet displacement from the correct direction exceeds the tolerance, there is a problem that the apparatus is subject to machine halt state which will cause the down time for maintenance such as replacing the worn-out rollers.

2) In case of the above trouble where the displacement exceeding the tolerance occurs frequently, adjustment and recovering require a long period of time because there is not information to identify a cause of the image position displacement and a place where the trouble occurs.

3) Also, in case of a Print On Demand (POD) machine, requirements for positioning of obverse and reverse image are sever. Thus images having the displacement exceeding the tolerance is judged as a failure, and in many cases, the transfer sheets are all disposed.

4) Further, in case of large amount printing, though the positions of obverse and reverse images are adjusted with high accuracy at initial stage, due to change with age of mechanical characteristic and deviation of the sheet, there is a concern that mass printing is carried out in a state where the displacement of obverse and reverse positions exceeds the tolerance.

### SUMMARY OF THE INVENTION

In view of the foregoing, an object of the present invention is to provide new an image forming apparatus, a maintenance management method thereof and an image forming system. Still another object of the present invention is to provide an image forming apparatus, which presents maintenance and checking time through textural information and voice, a maintenance management method thereof and an image forming system.

The above object is solved by the following configuration:

1) An image forming apparatus, having: an image forming device to form an image based on image information on a prescribed surface of a transfer material and a mark image for image position identification at a prescribed position on the transfer material; a detecting device to detect a position of the mark image formed by the image forming device on the transfer-material and output position information; a memory device to memorize the position information detected by the detecting device; and a control device to statistically process the position information memorized in the memory device.

According to the image forming apparatus related to 1), the image forming device forms the image on the prescribed transfer material based on the image information as well as the mark image indicates the image position of as the prescribed position on the transfer material. The detecting device detects the position of the mark image formed by the image forming device on the transfer material and outputs the position information. The memory device memorizes the position information detected by the detecting device. Thereby, the control device statistically processes the position information memorized in the memory device. As a result, the tendency and characteristic of the displacement of the mark image analyzed quantitatively with time can be understood.

2) A maintenance management method of an image forming apparatus, having steps of: forming an image based on image information on a prescribed surface of a transfer material and a mark image for image position identification at a prescribed position on the transfer material; detecting a position of the mark image formed on the transfer material to obtain position information; storing the position information obtained; processing the position information stored statistically; and presenting a maintenance time of the image forming apparatus based on the statistical processing.
3) An image forming system, having: an information processing apparatus; an image forming apparatus, capable of communication processing with the information processing device via a communication device, including, an image forming device to form an image based on the image information on a prescribed surface of the transfer material as well as to form a mark image for image position identification at a prescribed position of the transfer material, a detecting device to detect a position of the mark image formed on the transfer material by the image forming device and to output position information, a memory device to memorize the position information detected by the detecting device, and a control device to transfer the position information read from the memory device to the image processing apparatus; wherein the information processing apparatus receives the position information from the image forming apparatus and executes statistical processing.

According to the image forming system related to 3), since the image forming device related to 1) and the maintenance management method of the image forming device related to 2) can be used, by receiving transfer of the position information from the image forming device, the distribution of the each element in the displacement amount of the mark image on the transfer material is investigated at the information processing device side, and the statistic processing to analyze the tendency and the characteristic of the displacement quantitatively.

### BRIEF DESCRIPTION OF THE DRAWINGS

FIG. 1 is a conceptual diagram showing an exemplary configuration of a color printer 100 representing a first exemplary embodiment related to the present invention.

FIG. 2 (A) is an obverse side view showing a relation (1) between benchmarks Mi and an obverse side image on a transfer sheet P′.

FIG. 2 (B) is a reverse side view showing a relation (1) between benchmarks Mi and an obverse side image on a transfer sheet P′.

FIG. 2 (C) is a reverse side view showing a relation (1) between benchmarks Mi and a reverse side image on ‘a transfer sheet P’.

FIG. 3 (A) is a view showing a relation (2) between benchmarks Mi and a reverse side image on a transfer sheet P′.

FIG. 3 (B) is a view showing a relation (2) between benchmarks Mi and a reverse side image on a transfer sheet P′.

FIG. 3 (C) is a view showing a relation (2) between benchmarks Mi and a reverse side image on a transfer sheet P′.

FIG. 4 is a block diagram showing an exemplary configuration of a control system of a color printer 100.

FIG. 5 (A) is a top view showing an example of position detection of benchmarks Mi

FIG. 5 (B) is a time chat showing an output of a CIS at a point A in an example of position detection of benchmarks Mi

FIG. 5 (C) is a time chat showing an output of a CIS at a point B in an example of position detection of benchmarks Mi

FIG. 5 (D) is a histogram of pixel in an example of position detection of benchmarks Mi.

FIG. 6 (A) is a time chart of a trigger signal S15 in an exemplary operation of a mark image forming section 13.

FIG. 6 (B) is a time chart of a mark sensor 11 in an exemplary operation of a mark image forming section 13.

FIG. 6 (C) is a time chart of a horizontal synchronizing signal SH in an exemplary operation of a mark image forming section 13.

FIG. 6 (D) is a time chart of a mark detection data D11 in an exemplary operation of a mark image forming section 13.

FIG. 6 (E) is a time chart of a mark sensor 12 in an exemplary operation of a mark image forming section 13.

FIG. 6 (F) is a time chart of a horizontal synchronizing signal SH in an exemplary operation of a mark image forming section 13.

FIG. 6 (G) is a time chart of mark detection data D12 in an exemplary operation of a mark image forming section 13.

FIG. 6 (C′) is a magnified time chart of a horizontal synchronizing signal SH in an exemplary operation of a mark image forming section 13.

FIG. 6 (D′) is a magnified time chart of a mark detection data D11 in exemplary operation of a mark image forming section 13.

FIG. 7 is a table showing an exemplary configuration of a database of a displacement amount ε in a memory section 30.

FIG. 8 is a graph showing an exemplary transition of a displacement amount ε.

FIG. 8 is a graph showing an exemplary variance of a displacement amount ε.

FIG. 10 is a conceptual diagram showing an exemplary warning display in an operation setting screen G16.

FIG. 11 is a flow chart showing an exemplary statistic processing in a color printer 100.

FIG. 12 is a conceptual diagram showing an exemplary configuration of a color printer 200 representing a second exemplary embodiment.

FIG. 13 is a conceptual diagram showing an exemplary configuration of a color printer 300 representing a second exemplary embodiment.

### DETAILED DESCRIPTION OF THE PREFERRED EMBODIMENT

The following will describe an image forming apparatus, a maintenance management method and an image forming system related to the embodiment of the invention with reference to the drawings.

### Embodiment 1

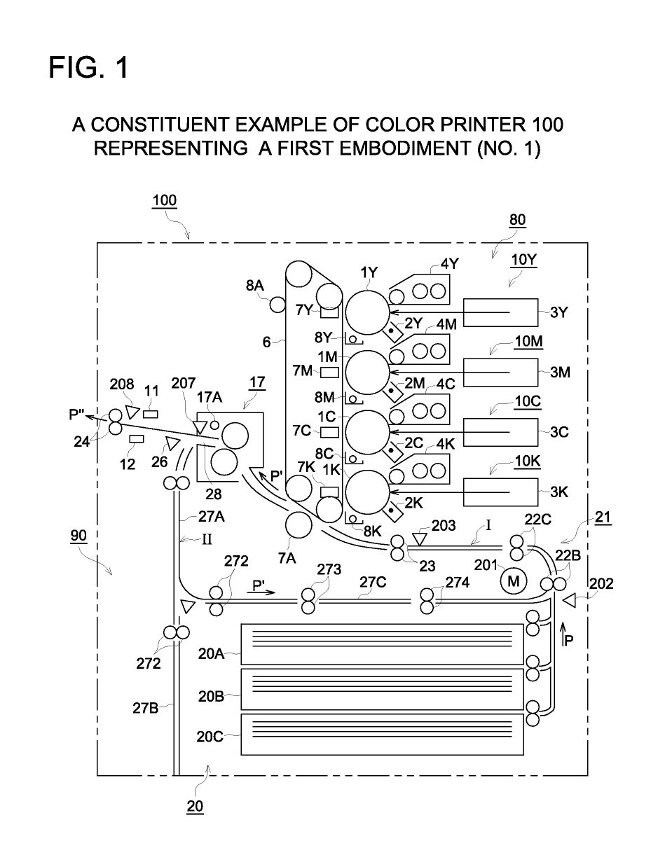

FIG. 1 is a schematic diagram showing a constituent example of a color printer 100 representing a first embodiment related to the present invention. The tandem type color printer 100 shown in FIG. 1 constitutes an example of an image forming apparatus and has a double-side image forming mode, Here, the double-side image forming mode means that color images are formed on an obverse and a reverse side of a predetermined sheet based on digital color image information. The color image information is supplied from external apparatuses such as person computers and scanners to the printer 100 and transferred to an image forming section 80.

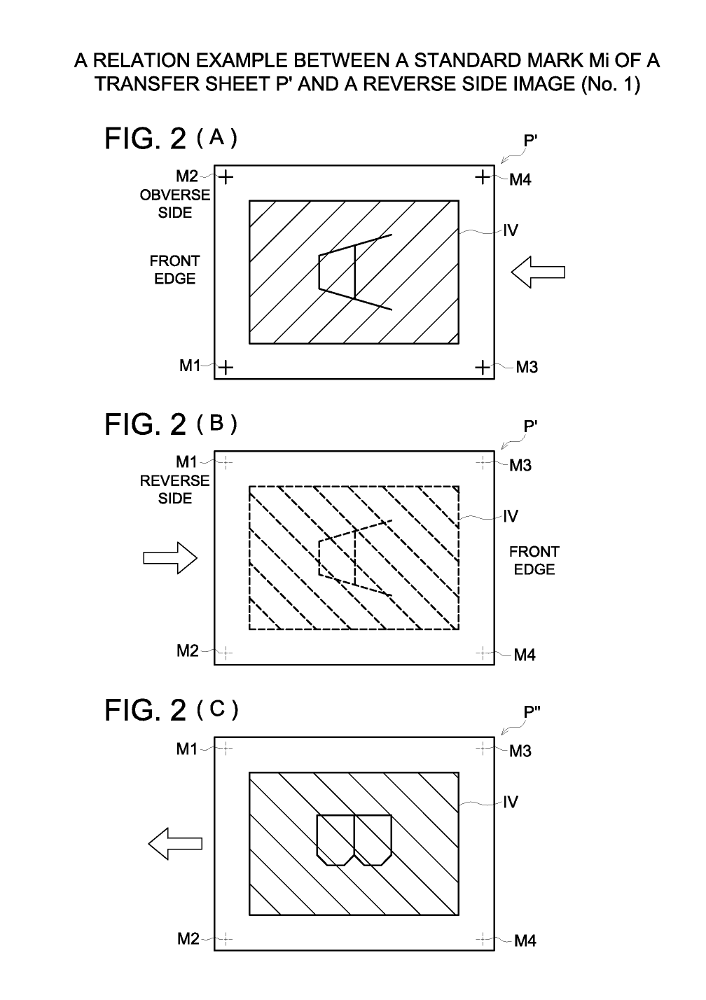

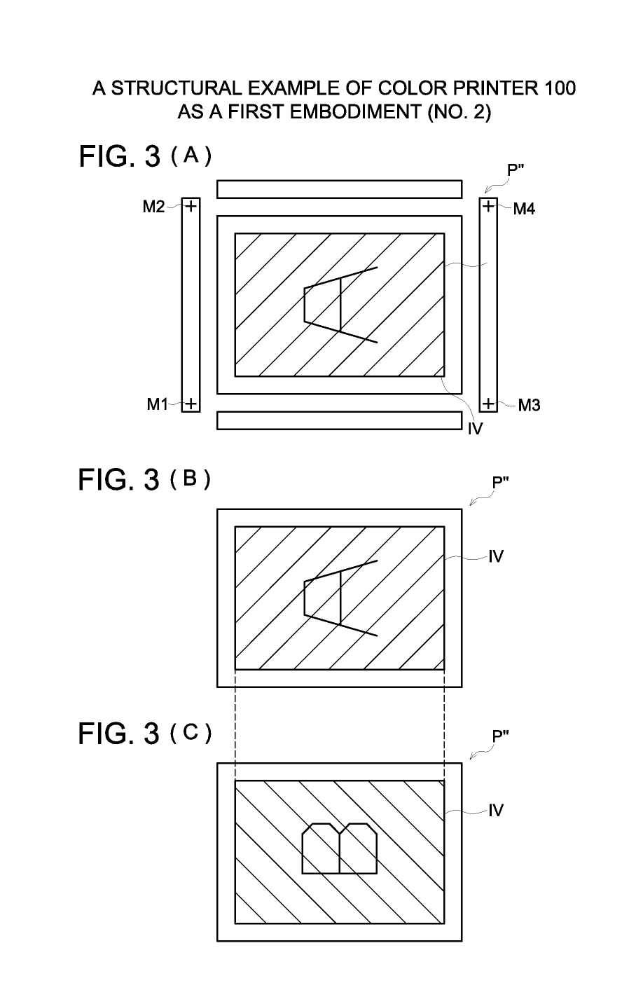

In this example, the image forming section 80 configuring a function of an image forming device forms an image in a predetermined side of a sheet P based on the image information, as well as benchmarks (register mark) configuring examples of mark images to identify the image position in a predetermined position of the sheet P. The benchmarks are formed along with the obverse image at four corners of the sheet outside an image forming area, and in double-side image forming mode, besides the obverse side, the marks are formed along with a reverse side image on the reverse side (refer to FIG. 2 and FIG. 3). The bench marks are detected so as to judge whether or not the image position on the obverse surface of the sheet equates with the image position of the reverse surface of the sheet within the tolerance.

The image forming section 80 is provided with an image forming unit 10Y having a photo conductive drum 1Y for yellow (Y) color, an image forming unit 10M having a photo conductive drum 1M for magenta (M) color, an image forming unit 10C having a photo conductive drum 1C for cyan (C) color, an image forming unit 10K having a photo conductive drum 1K for black (K) color, and an intermediate transfer belt 6. In the image forming section 80, image forming is carried out respectively for the photoconductive drums 1Y, 2M, 1C and 1K and the toner images formed on the respective photoconductive drums 1Y, 2M, 1C and 1K are superimposed on the intermediate transfer belt 6 to form a color image.

In this example, besides the photoconductive drum 1Y, image forming unit 10Y has a charging device 2Y, writing unit 3Y, developing unit 4Y and a cleaning section 8Y for an image forming substance so as to form a yellow (Y) color image. The photoconductive drum 1Y configuring an example of an image carrier is, for example, provided rotatably at right upper side of the intermediate transfer belt 6 close to it to form a yellow color toner image. In this example, the photoconductive drum 1Y is rotated by an unillustrated driving mechanism in an anticlockwise direction. On a right oblique lower side of the photoconductive drum 1Y, the charging device 2Y is disposed so as to charge a surface of the photoconductive drum at a predetermined voltage.

At a position substantially immediately lateral to the photoconductive drum 1Y, the writing unit 3Y is provided opposite to the drum 1Y, so as to scan a laser beam of the yellow color having a predetermined intensity based on the image data for Y color. The writing unit 3Y has a laser light source and a polygon mirror, which are not illustrated.

The laser beam light is deflected and scanned by rotating the polygon mirror for Y color which is so-called “writing Y color image data in a main scanning direction”. The main scanning direction is a direction parallel to a rotation axis of the photoconductive drum 1Y. The photoconductive drum 1Y rotates in a sub-scanning direction. The sub-scanning direction is a direction perpendicular to the main scanning direction, namely a direction perpendicular to the rotation axis of the photoconductive drum 1Y. An electrostatic latent image is formed by rotation of the photoconductive drum 1Y in the sub-scanning direction, and by deflective scan of the laser beam light in the main scanning direction.

Above the writing unit 3Y, a developing unit 4Y is provided so as to operate developing of the electro static latent image of the Y color formed on the photoconductive drum 1Y. The developing unit 4Y has an unillustrated developing roller for the Y color. The developing unit 4Y stores Y color toner agent and carrier.

The developing roller for the Y color having a magnet inside conveys binary developer, obtained by mixing the carrier and the Y color toner in the developing unit 4Y, to a facing portion of the photoconductive drum 1Y by rotation so as to develop the electrostatic latent image by Y color toner. The Y color toner image formed on the photoconductive drum 1Y is transferred onto the intermediate transfer belt 6 by operating a primary transfer roller 7Y (first transfer). At lower left side of the photoconductive drum 1Y, a cleaning section 8Y is provided so as to clean the toner remained on the photoconductive drum 1Y at previous writing.

In the example, an image forming unit 10M is arranged below the image forming unit 10Y. The image forming unit 10M has a photoconductive drum 1M, a charging device 2M, a writing unit 3M, a developing unit 4M and a cleaning section 8M for the image forming substance so as to form a magenta (M) color image. An image forming unit 10C is arranged below the image forming unit 10M. The image forming unit 10C has a photoconductive drum 1C, a charging device 2C, a writing unit 3C, a developing unit 4C and a cleaning section 8C for the image forming substance so as to form a cyan (C) color image.

An image forming unit 10K is arranged below the image forming unit 10C. The image forming unit 10K has a photoconductive drum 1K, a charging device 2K, a writing unit 3K, a developing unit 4K and a cleaning section 8K for the image forming substance so as to form a black (K) color image. An organic photoconductor (POC) is used for the photoconductive drums 1Y, 1M, 1C and 1K.

Meanwhile, regarding functions of the image forming units 10M to 10K, for the components having the same symbols, descriptions will be omitted because the description of the image forming unit 10Y can be applied to the image forming units of other colors by replaced Y with M, C, and K. A primary transfer bias voltage, which has an opposite polarity (in the present embodiment positive polarity) to the toner in used is applied to the aforesaid primary transfer rollers 7Y, 7M, 7C and 7K.

The intermediate belt 6, configuring an example of an image carrier, superimposes the toner images transferred by the primary rollers 7Y, 7M, 7C and 7K so as to transfer the color toner image (color image) and the benchmark. For example, the color image formed on the intermediated transfer belt 6 is conveyed towards a secondary transfer roller 7A by rotating the intermediate transfer belt 6 in a clockwise direction. The secondary transfer roller 7A is located below the intermediate belt 6 so as to transfer the color toner image formed on the intermediate belt 6 onto the sheet P in a lump (secondary transfer). Here, the sheet P where the image and the benchmark are formed is called a transfer sheet P′. Toner left on the secondary transfer roller 7A during previous transfer can be removed (cleaning).

In this example, the cleaning section 8A is provided left above the intermediated transfer belt 6 to remove the remaining toner on the intermediate transfer belt 6. The cleaning section 8A has a discharging section (unillustrated) to discharge electric charge on the intermediate belt 6 and a pad to remove the remaining toner on the intermediate belt 6. With this cleaning section 8A, a belt surface is cleaned and then the intermediate belt 6 after being discharged by the discharging section enters into a next image forming cycle. Thereby, the color image can be formed on the sheet P.

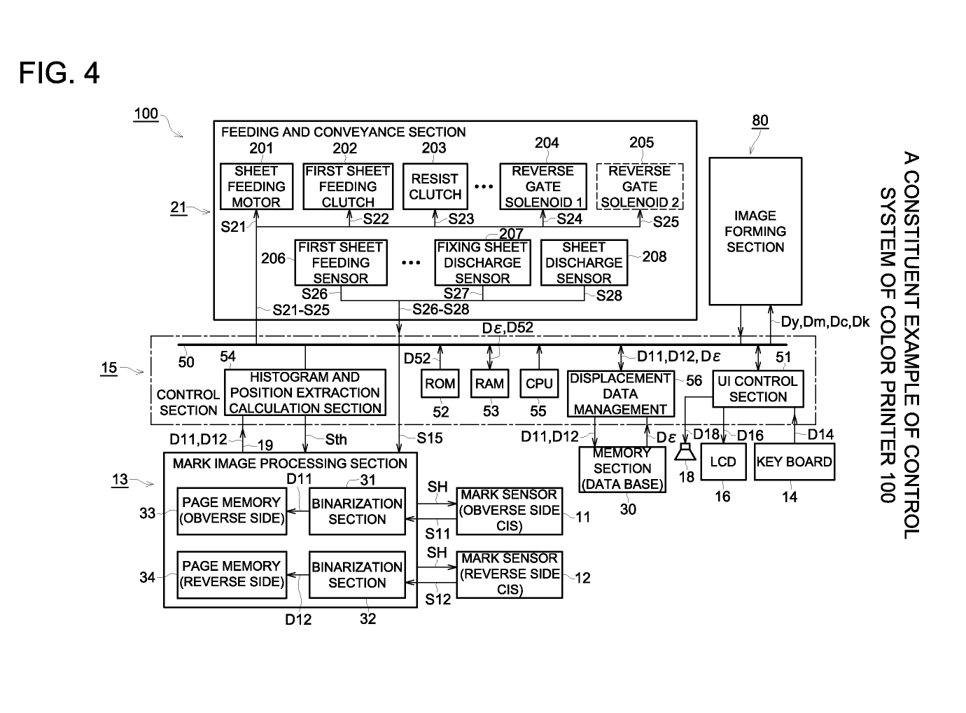

The color printer 100 is provided with a sheet supply section 20, a feeding conveyance section 21, a fixing unit 17 and a transfer sheet turning over section 90 besides the image forming section 80. Below the aforesaid image forming unit 10K, there is provided the sheet supply section 20 which is, for example, configured with three sheet feeding trays 20A, 20B and 20C. In each sheet feeding tray 20A, 20B and 20C, prescribed sizes of sheets are stored. In a sheet conveyance path from the sheet supply section 20 to a lower side of the image forming unit 10K, there are provide conveyance rollers 22A and 22C, a loop rollers 22B, and register rollers 23 which are controlled by a feeding conveyance section 21 shown in FIG. 4.

For example, the register rollers 23 carries the prescribed sheet P fed from the sheet supply section 20 in front of the secondary transfer roller 7A so as to convey the sheet P to the secondary transfer roller 7A in accordance with an image timing. The secondary transfer roller 7A transfers the color image carried by the intermediate belt 6 onto the prescribed sheet P which is controlled and conveyed by the register rollers 23.

A fixing unit 17 is provided at down stream side of the aforesaid secondary transfer roller 7A so as to carry out fixing process of the transfer sheet P′ on which a color image and the benchmarks are transferred. The fixing unit 17 has an unillustrated fixing roller, a pressure roller, a heater (IH), and a fixing cleaning section 17A. In fixing process, the transfer sheet P′ goes between the fixing roller which is heated by a heater and the pressure roller so that the transfer sheet P′ is heated and pressed. The transfer sheet after fixing process is grasped by discharging rollers 24 to be discharged to a discharge tray (unillustrated) outside the apparatus. A discharging direction of the transfer sheet P is the sub-scanning direction. The fixing cleaning section 17A cleans the toner remaining on the fixing roller in previous fixing.

The fixing unit 17 has a discharging sheet reversal gate 28. At the down stream side of the fixing unit 17, a transfer sheet turn over section 90 is provided to turn over the transfer sheet P′ on which the benchmarks and obverse image are fixed by the fixing unit 17. The transfer sheet turn over section 90 has a sheet reversal path II to turn the obverse side to reverse side. The sheet reversal path II is provided with a sheet circulating path 27A, a reversal conveyance path 27B and a sheet re-feeding section 27C. The reversal conveyance path 27B is provided with reversal rollers 271, and a sheet re-feeding section 27C is provided with reversal rollers 272 and conveyance rollers 273 and 274.

In this example, in the double-side image forming mode, the transfer sheet P′ which is the sheet P having the benchmarks and the image on its obverse surface is discharged from the discharging sheet reversal gate 28 of the fixing unit 17 and branched to the reversal sheet path II through a bifurcation section 26, then through the sheet circulating path 27A, the transfer sheet P′ is turned over by the reversal conveyance path 27B which configures the sheet re-feed mechanism (ADU mechanism), and through the sheet re-feeding section 27C, the transfer sheet P′ merges with a sheet feeding path I at loop rollers 22B of the sheet feeding path I.

In this example, at a downstream side of the bifurcation section 26 of a discharging position and at an upstream side of discharging rollers 24, a first and a second mark sensors 11 and 12 to configure an example of a detection device are arranged. The bifurcation section 26 is located at a discharging/turnover bifurcation point of the transfer sheet P′ after image forming. The mark sensors 11 and 12 detect a position of the benchmarks formed on the sheet P by the image forming section 80. The benchmarks are formed on one side and the other side of the transfer sheet P′ respectively. It is deemed that the displacement of the benchmarks is caused by change with time due to loose assembling of the image forming section 80 or wear of components. Hereinafter, the transfer sheet P on which both surfaces images are formed is called recording sheet P″.

Mark sensors 11 arranged at both right and left sides of a sheet discharging path detect positions of right and left benchmarks at front and rear edges on obverse side of the recording sheet P″ in a direction perpendicular to the sheet conveyance direction and outputs an obverse side mark detection signal S11. The obverse side mark detection signal S11 is outputted to the control section 15.

Mark sensors 12 arranged at both right and left sides of a sheet discharging path detect positions of right and left benchmarks at front and rear edges on reverse side of the recording sheet P″ in a direction perpendicular to the sheet conveyance direction and outputs an reverse side mark detection signal S12. The reverse side mark detection signal S12 is outputted to the control section 15. The obverse side mark detection signal S11 and the reverse side mark detection signal S12 includes position information of the benchmarks.

To detect the positions of the benchmarks with reference to the edge of transfer sheet P′(single-side image forming mode) or the recording sheet P″ (double-side image forming mode), it is preferred that the mark sensors 11 and 12 are located at an area where less curling or flopping of the sheet P′ or P″ occur. Reflection type optical sensors such as contact image sensors are used in the mark sensors 11 and 12. As above, by configuring the mark sensor 11 (CIS for obverse side detection) and mark sensor 12 (CIS for reverse side detection), the position information of the benchmarks of the transfer sheet P′ can be obtained right before sheet discharging with a superior reproducibility.

FIG. 2(A) to FIG. 2(C) and FIG. 3(A) to FIG. 3(C) are diagrams showing an exemplary relations 1 and 2 between the benchmarks Mi and reverse side images on the transfer sheet P′.

In this example, when the double-side mode is assigned, desired images are formed on both obverse and reverse surfaces of the sheet P. Redundant areas at four sides of recording sheet P″ after double-side print is cut away and removed. At a periphery of image forming area IV on the obverse and reverse surfaces of the recording sheet P″, an area having a color of the sheet P, for example white, in a shape of a frame will be formed.

On the sheet P shown by FIG. 2 (A), the benchmarks Mi (I=1 to 4), an obverse image, for example character “A”, and a background image are formed. The sheet P on which the benchmarks Mi and the obverse image have been formed becomes a transfer sheet P′. The benchmarks Mi are formed at four corners of the transfer sheet P″. In this example, two benchmarks M1 and M2 are formed at a front edged side of the transfer sheet P′. At a rear edge side of the transfer sheet P′ two benchmarks M3 and M4 are formed respectively. The benchmarks Mi are formed in a shape of a cross at the periphery of the image forming area IV on the obverse side of the transfer sheet P′.

When the transfer sheet P7 shown in FIG. 2 (B) is turned over, the front edge in a state of the sheet P comes the rear edge and the rear edge in the state of the sheet P becomes the front edge. The broken lines show the benchmarks Mi, the obverse image “A” and the background image. In this example, a front edge detecting sensor PS1 detects the front edge of transfer sheet P′ to output a front edge detection signal SP1 to the control section 15. A mark detecting sensor PS2 detects the benchmarks M3 and M4 to output mark detection signal SP2. In this way, the benchmarks M3 and M4 formed distantly from the front edge of the reverse side of the transfer sheet can be detected with superior reproducibility after turning over the transfer sheet.

A reverse side image, for example character “B”, and the background image, is formed on the reverse side of the transfer image P′ shown in FIG. 2 (C), however the benchmarks Mi are not formed. The transfer sheet P′ after forming the reverse side image becomes the recording sheet P′. At this time, the reverse side image is formed with reference to the benchmarks Mi formed on the obverse side.

In the recording sheet P″ shown in FIG. 3 (A), four corners in which the bench marks Mi are formed are cut away by an unillustrated cutting machine and removed. At the periphery of the image forming area IV on obverse and reverse side, for example, an area having white color of the sheet P is formed in a shape of a frame.

On the recording sheet P″ after the four corners at the periphery shown in FIG. 3 (B) are cut away, an area having a color of sheet P is formed in the shape of the frame, around the image forming area IV. Also at a periphery of a reverse side image forming area of the recording sheet P″ shown in FIG. 3 (C), an area having a color of sheet P is formed in the shape of the frame. Further, the image forming position of the obverse side and the image forming position the reverse side correspond each other. This is because the image forming position of the obverse side and the image forming position of the reverse side of the recording sheet P′ are aligned accurately by forming the reverse side image based on the benchmarks Mi which are detected with reference to the rear edge of the reverse side of the transfer sheet P after turning over.

Naturally, the recording sheet P″ can be cut away without the area having the color of the sheet P in the shape of the frame at the periphery thereof. In this case, the image forming positions of the obverse side and the reverse side of the recording sheet P″ can also be corresponded each other.

FIG. 4 is a block diagram showing an exemplary structure of a control system of the color printer 100. The color printer 100 shown in FIG. 4 has a mark sensor 11, mark sensor 12, a mark image processing section 13, a key board 14, a control section 15, a display section 16, a audio output section 18, a sheet feeding and conveyance section 21, a memory section 30 for a data base and an image forming section 80. The function of the image forming section 80 is as described in FIG. 1.

The control section 15 is configured with a system bus 50, an UI control section 51, a ROM (Read Only Memory) 52, a RAM (Random Access Memory) for work 53, histogram and a position extraction calculation section 54, a CPU (Central Processing Unit) 55 and a displacement data management section 56.

To the system bus 50, the UI control section 51 is connected so as to control input and output of user interfaces such as the keyboard 14, the display section 16, and the audio output section 18. For example, operation data D14 of system booting is inputted to the UI control section 51 through the keyboard 14.

The ROM 52 is connected to the CPU 55. In the ROM 52, there are stored a program data D52 to boot the system and to control entire printer. The RAM 53 temporary memories the program data D52, control commands for executing a statistical processing and the displacement data Dε. When the power is turned on, the CPU 55 reads out the system program data 52 from the ROM 52 and loads it on RAM 53 to start the system and control entire printer.

Besides the operation data D14, the aforesaid keyboard 14 is operated so as to input image forming conditions including; single-side or double-side, sheet size, paper type, basis weight, sheet feeding tray, and color mode or monochrome mode when forming image. Also, the UI control section 51 outputs display data D16 indicating a due time of statistical processing and maintenance to display section 16, and outputs the audio output data D18 indicating the due times of the statistical processing and the maintenance to the audio output section 18.

The mark sensor 11 (obverse side CIS) generates the mark detection signal S11 by detecting the benchmarks Mi of one side (obverse side) of the transfer sheet P′ based on a horizontal synchronizing signal SH. The mark sensor 12 (reverse side CIS) generates the mark detection signal S12 by detecting the benchmarks Mi of the other side (reverse side) of the transfer sheet P′ based on the horizontal synchronizing signal SH. The horizontal synchronizing signal SH is outputted from the mark image processing section 13 to the mark sensors 11 and 12.

The mark image processing section 13 is configured with binarization sections 31 and 32, page memories 33 and 34. To the aforesaid mark sensor 11 (obverse side CIS), the binarization section 31 is connected so as to binarize the mark detection signal S11 based on a trigger signal S15 and a threshold setting signal Sth and to output the mark detection data D11. The threshold setting signal Sth is a signal to set a binarization value of the mark detection signal S11.

The mark sensor 12 (reverse side CIS) connected to a page memory 33 binarizes the mark detection signal S12 based on the trigger signal 15 and the threshold setting signal Sth, and outputs the mark detection data D12. The trigger signal 15 and the threshold setting signal Sth are outputted from the control section 15 to the mark image processing section 13.

To the binarization section 31, a page memory 33 is connected so that the mark detection data D11 for one obverse page of the transfer sheet P′ is temporary memorized. To the binarization section 32, a page memory 34 is connected so that the mark detection data D12 for one reverse page of the transfer sheet P′ is temporary memorized. The mark detection data D11 and D12 are outputted from the mark image processing section 13 to the control section 15 through the data bus 19.

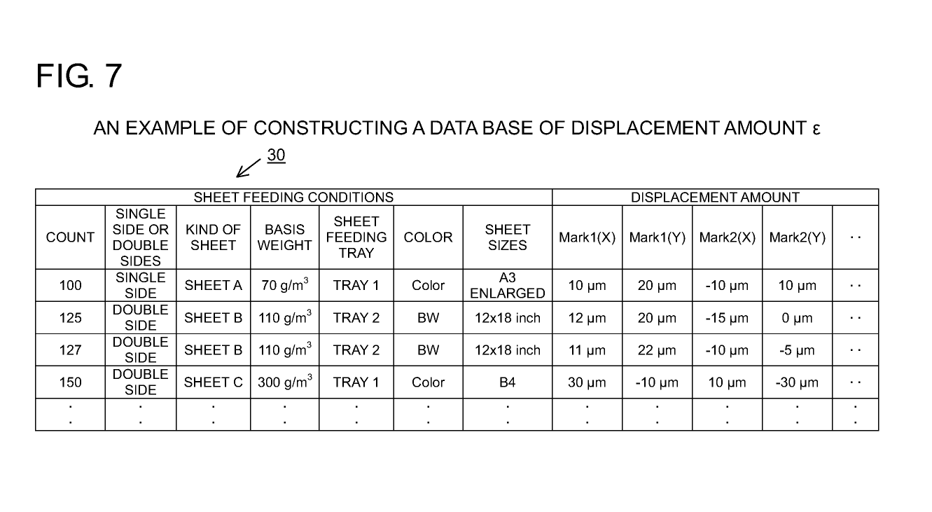

The memory section 30 configures an example of memory device for the data base so as to accumulate position information (hereinafter called displacement data Dε) related to the benchmarks Mi detected by the mark sensors 11 and 12. In memory section 30, the displacement data Dε of the benchmarks Mi are stored respectively for image forming conditions including; single side or double side, sheet size, paper type, basis weight, sheet feeding tray, and color mode or monochrome mode. For the memory section 30, non-volatile memory such as fixed hard disk (HDD) and EEPROM are used (refer to FIG. 7).

To the aforesaid system buss 50, besides the aforesaid UI control section 51, a ROM 52, a RAM 53 and the CPU 55, a histogram & position extraction calculation section 54 and the displacement data management section 56 are connected. The histogram & position extraction calculation section 54 carries out a process to identify the position of the benchmarks Mi based on the output of the mark sensors 11 and 12. The displacement managing section 56 manages the displacement data Dε accumulated in the memory section 30 necessary for statistical processing, collaborating with the CPU 55.

The CPU 55 controls the histogram & position extraction calculation section 54 and the displacement data management section 56 so as to carry out the statistical processing of the data Dε memorized in the memory section 30. In this example, the CPU 55 reads out the displacement data Dε from the memory section 30, verifies a distribution of each element in a displacement amount ε of the benchmarks Mi of the transfer sheet P′ or the recording sheet P″ based on the aforesaid displacement data Dε and executes a quantitative analysis of characteristic and tendency of the displacement amount ε.

In the statistical processing, CPU 55 calculates the change of the displacement amount ε with time based on the displacement data Dε accumulated in memory section 30. For example, CPU 55 executes statistical processing of the accumulated displacement data Dε for every image forming conditions. In this example, CPU 55 executes statistical processing of the displacement amount of ε of the recording sheet P″ or transfer sheet P′ detected by the mark sensors 11 and 12, respectively for the image forming conditions including: single-side, double-double, sheet size, type of paper, basis weight, sheet tray, color mode and monochrome mode. In this way, the tendency and characteristic of displacement amount of ε of the benchmarks Mi analyzed quantitatively with time can be understood respectively for the image forming conditions.

In this example, the CPU 55 judges whether or not the position of the image based of the image information is in a predetermined position and whether or not the displacement amount of the benchmarks Mi is within the tolerance. In this way, whether or not the position of the image is at the predetermined position on the transfer sheet P′ can be judged without directly detecting the position of the image based on the image information. For example, to judge whether the displacement mount ε is large or small, first and second thresholds εth1 and εth2 are set.

The CPU 55 compares the displacement amount ε detected by the mark sensors 11 and 12, with the first threshold εth1 so that a first warning display process is executed when the displacement amount ε exceeds the threshold εth1. The threshold εth1 is to evaluate the tolerance of displacement, and is a comparison criterion value to judge whether or not the displacement amount ε of the benchmarks Mi is within the tolerance. In this example, if the threshold εth1 exceeds, machine halt state or re-printing (retry) proceed. In this way, machine stopped state or re-print (retry) executed to cope with an accidentally large displacement are smoothly handled.

In the above example, the second threshold εth2 smaller than the threshold εth1 is further assigned. The threshold εth2 is assigned to judge the maintenance time. The CPU 55 compares the displacement amount ε processed by statistical processing with the threshold εth2 so that the second warning display process to urge maintenance of the apparatus is executed when the displacement amount ε processed by statistical processing exceeds the threshold εth2. Thereby a downtime in the maintenance time can be reduced.

In this example, the CPU 55 displays the transition of the displacement amounts ε respectively for the image forming conditions based on analysis information obtained through the statistical processing of the displacement data Dε on a display 16. Thereby, the user can visually confirm the maintenance times respectively for the image forming conditions through a displayed screen image.

The CPU 55 is connected with the display section 16 configuring an exemplary presenting device on which maintenance checking time (maintenance time) of the color printer 100 based on the statistical processing besides the image forming conditions based on displayed data D16 is presented. For example, the display section 16 displays a transition accompanied by the change with time of the displacement amount ε of the benchmarks Mi. The displayed data D16 is data to display the image forming conditions, the change and the transition of the displacement amount ε and the maintenance time. The display section 16 displays, for example, a warning message based on the display data D16 when the displacement data Dε exceeds the threshold εth1. The displayed data D16 is outputted from the CPU 55 to the display section 16.

To the CPU 55, besides the display section 16, an audio output section 18 configuring the other exemplary presenting device is connected so that when the maintenance time of the color printer 100 is due, for example, “It is a time for maintenance” is announced based on the audio output data D18 based on the statistical processing. Thereby, this makes it possible for the user to confirm the maintenance time with the displayed screen image and the audio output. The aforesaid audio output section 18 also configures the presenting device.

The feeding conveyance section 21 is configured with a sheet feeding motor 201, a first sheet feeding clutch 202, a register clutch 203, solenoids 204 and 205 for a turning over gate, a first sheet feeding sensor 206, a fixing and discharging sheet sensor 207, and a discharging sensor 208.

By inputting a motor control signal S21, the sheet feeding motor 201 drives conveyance rollers 22A and 22C of sheet conveyance path I shown in FIG. 1, a loop roller 22B and a transfer sheet turnover section 90. The first sheet clutch 202 connects and disconnects an unillustrated feeding roller of the sheet feeding section 20 by inputting a clutch signal S22. The register clutch 203 connects and disconnects the resist roller 23 by inputting a clutch control signal S23.

The solenoid 204 controls the bifurcation section 26 so as to change over the destination of transfer sheet P′ and recording sheet P″ by inputting a solenoid control signal S24. Meanwhile, in the figure, the solenoid 205 shown by broken lines is necessary for the second exemplary embodiment which is used to change over the sheet discharging turn over gate 28.

The first sheet feeding sensor 206 outputs a sheet detecting signal S26 to the CPU 55 by detecting the sheet P fed from one of the sheet trays 20A of the sheet feeding section 20. The fixing and discharging sensor 207 detects the transfer sheet P′ or recording sheet P″ which have been fixed and the outputs fixing detecting signal S27 to the CPU 55. The discharging sheet sensor 208 detects the transfer sheet P′ or recording sheet P″ discharged from the discharging sheet conveyance path to an unillustrated discharging tray and outputs the discharging sheet detection signal S28 to the control section 15.

As above, the control system of the color printer 100 is configured.

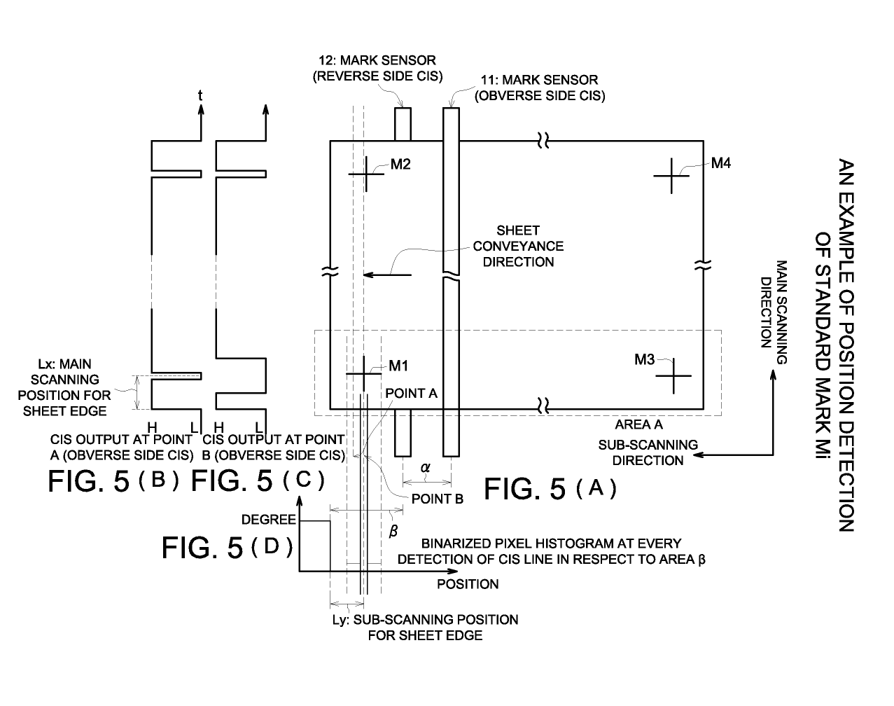

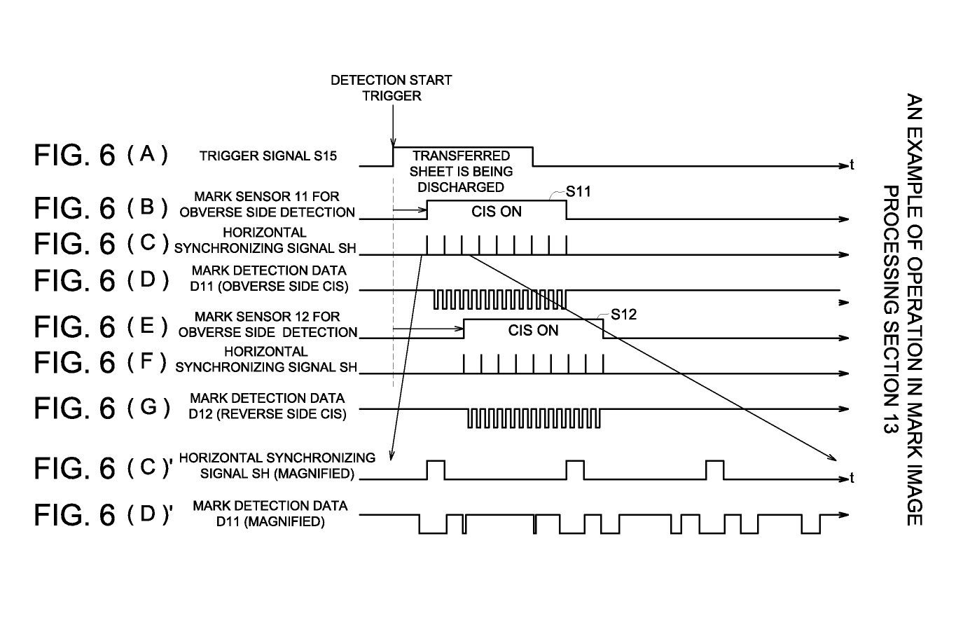

Subsequently, an example of position detection of the benchmarks Mi is described. The FIGS. 5(A) to 5(D) are top views to show an example of position detection of the benchmarks Mi and time charts. The benchmarks (register marks) M1 to M4 in a shape of cross exist at four corners on the surface of the transfer sheet P′ on which the image is already formed as shown in FIG. 5A. Meanwhile, at four corners of the obverse surface of the recording sheet P″, on which an image is formed in the double-side image forming mode, black color benchmarks M1 to M4 exist, and at four corners of the reverse surface, benchmarks M1 to M4 also exist.

In the figure, the example shows a case that by setting a point A and a point B are set on the sub-scanning direction, and extending the point B in the main scanning direction, displacement occurred between a center of benchmark M1 and a center of the benchmark M2 is indicated.

The mark sensor 11 (CIS for obverse side) is located at an obverse surface side of the transfer sheet P7 or recording sheet P″ and the mark sensor 12 (CIS for reverse side) is located at a reverse surface side of the transfer sheet P7 or recording sheet P″. The mark sensors 11 and 12 are arranged maintaining a positional difference α in the sub-scanning direction. The position difference α is to prevent an interference between detection of the benchmarks M1 to M4 on the obverse surface by the mark sensor 11 and detection of the benchmarks M1 to M4 on the reverse surface by the mark sensor 12.

The mark detection signal 11 shown in FIG. 5B is a diagram of an output wave of the mark sensor 11 (obverse surface CIS) at the point A shown in FIG. 5(A). When the mark detection signal 11 is at a high level (hereinafter called “H” level) the mark is not detected. The mark detection signal S11 becomes the “H” level because the mark sensor 11 detects white color of the sheet which is, for example, the color of a peripheral section of the transfer sheet P′. When the mark detection signal S11 is at a low level (hereinafter called “L” level) the mark is detected. The mark detection signal S11 becomes the “L” level because the mark sensor 11 detects color of the benchmarks Mi which is, for example, the mark sensor 11 detects a longitudinal (parallel to the sub-scanning direction) bar section or lateral (perpendicular to the sub-scanning direction) bar section of the benchmark in black color.

In this example, when the mark sensor 11 at point A detects the longitudinal bar section of the benchmark M1 in the shape of the cross on one side, the “H” level changes to the “L” level and changes to the “H” level again. When the mark sensor 11 detects the longitudinal bar section of the benchmark M2 on the other side, the “H” level changes to the “L” level and changes to the “H” level again.

In FIG. 5B, a time period Lx is a time converted from a distance from an side edge of the transfer sheet P′ to a center of benchmark M1, and shows a main scanning position of the benchmark M1 in respect to the side edge of the transfer sheet P′.

The mark detection signal 11 shown in FIG. 5 (C) is a diagram of an output wave of the mark sensor 11 (obverse surface CIS) at the point B shown in FIG. 5(A). In this example, when the mark sensor 11 detects the lateral bar section of the cross representing the benchmark M1 on one side, the “H” level changes to the “L” level and changes to the “H” level again. At this stage, a time period of the “L” level of the mark detection signal 11 reflects a length of the lateral bar section. In this example, there is occurred displacement at the lateral bar section of the benchmark M2 on the other side. Thus since it is just before detecting the lateral bar section, the same wave shape is obtained as that when the longitudinal bar section was detected at point A.

FIG. 5(D) is a diagram showing an example of creating a histogram of β section which is an area including the benchmark M1. According to the example of creating the histogram shown in FIG. 5(D), a vertical axis represents number of pixels showing the level “L” of the mark detection signal S11 after binarizing, and a horizontal axis is a position of the benchmark M1 in sub-scanning direction.

According to this example, in the section β including the benchmark M1 shown in FIG. 5D, each time one the benchmarks M1 and M2 detects one line in the main scanning direction, there is obtained a histogram, where numbers of pixels obtained by binarizing level “L” of the mark detection signal S11 are cumulatively added, for a position in the sub-scanning direction of the benchmarks M1 and M2. The center position of the benchmarks M1 and M2 are extracted for a frequency distribution of the histogram.

In FIG. 5(D), a time period Ly is obtained by converting a distance from a sheet front edge of the transfer sheet P′ to the center position of the benchmark M1, indicating the sub-scanning position of the benchmark M1 in respect to the sheet front edge of the transfer sheet P′.

Next, an exemplary operation in the mark image processing section 13 will be described. FIG. 6 (A) to FIG. 6 (G) are time charts showing an exemplary operation in the mark image processing section 13.

In these example, binarization process of the displacement amount ε of benchmark Mi is started when the trigger signal S15 for detection start shown in FIG. 6 (A) rises from the “L” level to the “H”. The trigger signal 15 is supplied from the control section 15 to the mark image processing 13 based on the fixing detecting signal S27 outputted from the fixing sheet sensor 207.

The mark detection signal S11 shown in FIG. 6 (B), which is an output of mark sensor 11 (obverse side CIS), shifts to the “H” level after elapse of a predetermined time from rising of the trigger signal S15. In this time period of the “H” level, a horizontal synchronizing signal SH shown in FIG. 6 (C) is supplied from the mark image processing section 13.

Mark detection data D11 shown in FIG. 6(D) is obtained by binarizing the mark detection signal S11 in the binarization section 31 based on the threshold setting signal Sth, and outputted form the binarization section 31 to a page memory (obverse side) 33.

The mark detection signal S12 shown in FIG. 6(E), which is an output of the mark sensor 12 (reverse side CIS), shifts to the “H” level after elapse of a predetermined time from rising of the trigger signal S15. In this time period of the “H” level, the horizontal synchronizing signal SH shown in FIG. 6 (F) is supplied from the mark image processing section 13.

Mark detection data D12 shown in FIG. 6(G) is obtained by binarizing the mark detection signal S12 in the binarization section 32 based on the threshold setting signal Sth, and outputted form the binarization section 32 to a page memory (obverse side) 34.

The mark detection data D11 and D12 described above is outputted from the page memories 33 and 34 of the image processing section 13 to the histogram & position extraction calculation section 54 of the control section 15 via a data bus 19.

In this example, within an enlarged wave timing period of the horizontal synchronizing signal SH shown in FIG. 6C, the mark detection data D11 shown in FIG. 6(D′) includes; “L” level data indicating the longitudinal bar section in black color necessary to form a histogram of the bench mark M1 (left side) in the shape of the cross, and “L” level data indicating the longitudinal bar section in black color necessary to form a histogram of the bench mark M2 (right side) in the shape of the cross, following “L” level data corresponding to black color of a portion where the paper does not exist.

Within an enlarged wave timing period of the horizontal synchronizing signal SH shown in FIG. 6(C′), the mark detection data D11 shown in FIG. 6(D′) includes “L” level data indicating the lateral bar section in black color of the bench mark M1 and “L” level data indicating the lateral bar section in black color of the bench mark M2.

In an enlarged wave timing period of the next horizontal synchronized signal SH shown in FIG. 6 (C′), the mark detection data D11 shown in FIG. 6 (D′) includes data of “L” level indicating the lateral bar portion in black color of the benchmark M1 and data of “L” level indicating the lateral bar portion in black color of the benchmark M2.

In the histogram & position extraction calculation section 54, a histogram, where the number of the pixels of “L” level of the mark detection data D11 shown in FIG. 6 (D′) is cumulatively added, is obtained in respect to the enlarged wave timing period of the horizontal synchronizing signal SH shown in FIG. 6, namely the positions in the sub-scanning direction of the benchmarks M1 and M2 for each line in the main scanning direction. Also, the center position of the benchmarks M1 and M2 is extracted from a frequency distribution of the histogram (FIG. 5D).

FIG. 7 is a table showing an example of configuring a data base on the displacement amount ε. According to the example of configuring the data base of the displacement amount ε shown in FIG. 7, the image forming (sheet feeding) conditions and the displacement amount ε of the benchmarks Mi are interrelated each other and stored in the memory section 30. The image forming condition are categorized into seven items such as count (quantity of transferring), single-side/double-side, type of paper, basis weight, sheet feeding tray, color mode (color/monochrome), sheet size. The displacement amount ε is categorized respectively for the benchmarks Mi such as Mark 1(x), Mark 2(X), Mark2(Y) . . . .

The benchmarks M1 to M4 shown in FIG. 2, are corresponded as follow: M1=Mark1(X), M2=Mark1(Y), M3=Mark2(X) and M4=Mark2(Y).

In this example, when the quantity of transferring reaches (count) to 100, the single-side/double-side image forming mode is “single-side”, sheet type is “sheet A”, the basis weight is 70 g/m³, the sheet feeding tray is “tray 1” and the color mode is “color” and the sheet size is “A3 extra”, and the displacement amount ε at Mark 1(X) is 10 μm, at Mark 1(Y) is 10 μm, at Mark 2(X) is −10 μm and at Mark 2(Y) is 10 μm.

Also, when the quantity of transferring reach (count) to 125, the single-side/double-side image forming mode is “double-side”, the sheet type is “sheet B”, the basis weight is 70 g/m³, the sheet feeding tray is “tray 1” and the color mode is “color” and the sheet size is “A3 extra”, and the displacement amount ε at Mark 1(X) is 10 μm, at Mark 1(Y) is 10 μm, at Mark 2(X) is −10 μm and at Mark 2(Y) is 10 μm.

Also, when the quantity of transferring reach (count) to 127, the single-side/double-side image forming mode is “double-side”, the sheet type is “sheet B”, the basis weight is 110 g/m³, the sheet feeding tray is “tray 2” and the color mode is “color” and the sheet size is “12×18 inch”, and the displacement amount ε at Mark 1(X) is 11 μm, at Mark 1(Y) is 22 μm, at Mark 2(X) is −10 μm and at Mark 2(Y) is −5 μm.

Also, when the quantity of transferring reach (count) to 150, the single-side/double-side image forming mode is “double-side”, the sheet type is “sheet C”, the basis weight is 300 g/m³, the sheet feeding tray is “tray 1” and the color mode is “color” and the sheet size is “B4”, and the displacement amount ε at Mark 1(X) is 30 μm, at Mark 1(Y) is −10 μm, at Mark 2(X) is 10 μm and at Mark 2(Y) is −30 μm.

Therefore, according to the exemplary configuration of the data base of displacement amount ε, the image forming (sheet feeding) conditions categorized into 7 items such as the count (the quantity of the transfer sheet), the single-side/double-side, the sheet type, the basis weight, the sheet feeding tray, the color mode (color/BW) and the sheet size are corresponded to the displacement amount ε categorized into respective benchmarks Mi such as Mark 1(X), Mark 1(Y), Mark 2(X) and Mark 2(X), and stored into the memory section 30. Thereby, the tendency and the characteristic of the displacement amount ε of the benchmarks Mi analyzed quantitatively with time can be understood.

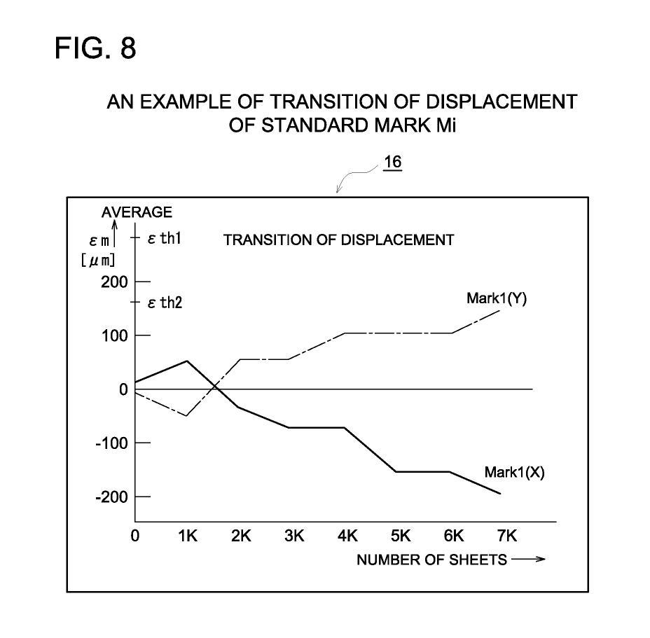

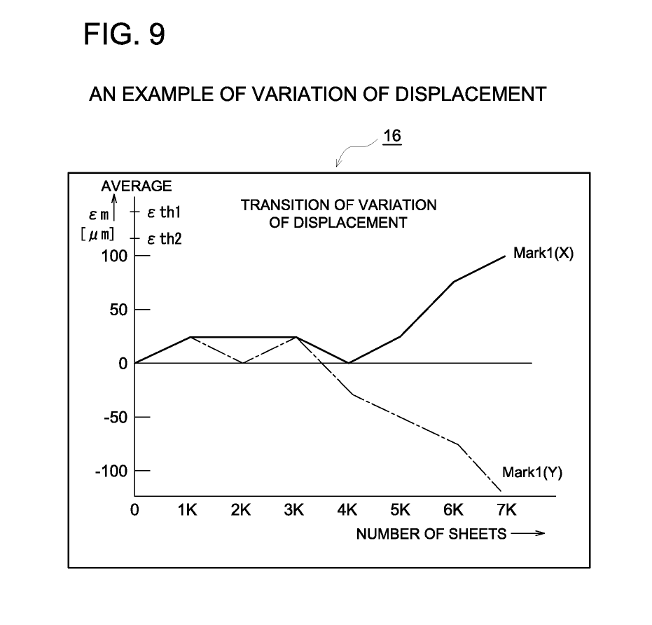

FIG. 8 is a diagram showing an exemplary transition of the displacement amount of the benchmarks Mi. In the exemplary transition of the displacement amount shown in FIG. 8, a longitudinal axis is of an average displacement amount cm and the scale unit is 100 μm. A lateral axis is of the quantity of the transfer sheet and the scale unit is 1000 sheets (1K). As the image forming conditions, “tray 1” and “double-side image forming mode” were selected, and the printing processing was carried out with the image forming conditions thereof with time. The exemplary transition of the displacement amount of the benchmarks Mi is shown on the display section 16.

A line graph of Mark 1 (X) shows an exemplary transition of the benchmark M1. The line graph of Mark 1 (Y) shows the transition of the displacement of the benchmark M2. As the average displacement amount εm, the first and the second threshold εth 1 and εth 2 are assigned. The thresholds εth 1 and εth 2 are set, for example, to a plus (+) side. According to the exemplary line graph of Mark 1 (X), after the average displacement amount εm in plus (+) direction reaches to a peak at around 1000 pieces (1K), the average displacement amount εm changes to a minus (−) direction. As the quantity of the transfer sheets increases to 2000 pieces (2K), 3000 pieces (3K), 4000 pieces (4K), 5000 pieces (5K) and 6000 pieces (6K), it is understood that the average displacement amount εm tends to gradually increase in the minus (−) direction to −100 μm and −200 μm.

According to the exemplary line graph of Mark 1 (Y), after the average displacement amount εm in the plus (−) direction reaches to a peak at around 1000 pieces (1K), the average displacement amount εm changes to the plus (+) direction. As the quantity of the transfer sheets increases to 2000 pieces (2K), 3000 pieces (3K), 4000 pieces (4K), 5000 pieces (5K) and 6000 pieces (6K), it is understood that the average displacement amount εm tends to gradually increase in the plus (+) direction to 100 μm and 200 μm. Thereby, the tendency and characteristic of the average displacement amount εm of the benchmarks M1 and M2 analyzed quantitatively with time can be understood. Therefore, the down time for maintenance of the printer 100 can be reduced.

FIG. 9 is a diagram showing an exemplary variation of the displacement amount of the benchmarks Mi. In the exemplary variation of the displacement amount shown in FIG. 9, a longitudinal axis is of a variance displacement amount εm and the scale unit is 100 μm. A lateral axis is the quantity of the transfer sheets and the scale unit is 1000 sheets (1K). As the image forming conditions, “tray 1” and “double-side image forming mode” were selected, and the printing processing was carried out with the image forming conditions thereof with time. The exemplary variation of the displacement amount of the benchmarks Mi is shown on the display section 16.

A line graph of Mark 1 (X) shows an exemplary variation of the benchmark M1. The line graph of Mark 1 (Y) shows the exemplary variation of displacement of the benchmark M2. As the variance displacement amount εm, the first and the second thresholds εth 1 and εth 2 are assigned.

According to the exemplary line graph of Mark 1 (X), it is understood that after the variance displacement amount εm in the plus (+) direction is stabilized at around 1000 pieces (1K), the variance displacement amount εm does not change in an area where the quantity of the transfer sheets reaches from 2000 pieces (2K) to 3000 pieces (3K). After around 3000 pieces (3K), the variance displacement amount εm changes to the minus (−) direction, then changes to the plus (+) direction after the quantity of the transfer sheets reaches to 4000 (4K) pieces and the variance displacement amount εm gradually increases to 50 μm and 10 μm in the plus (+) direction, as the number of the transfer sheets increases to 5000 pieces (5K) and 6000 pieces (6K).

According to the exemplary line graph of Mark 1 (X), it is understood that after the variance displacement amount εm in the plus (+) direction reaches to a peak at around 1000 pieces (1K), the variance displacement amount εm changes to the minus (−) direction and changes to the plus (+) direction again when the transfer sheets reaches at around 2000 pieces (2K), and then changes to the minus (−) direction at around 3000 pieces (3K). Thereafter, the variance displacement amount εm tends to increased in the minus (−) direction to −50 μm and −100 μm as the number of the transfer sheets increases to 5000 pieces (5K) and 6000 pieces (6K). Thereby, the tendency and characteristic of the variance displacement amount εm of the benchmarks M1 and M2 analyzed quantitatively with time can be understood. As a result, the down time for maintenance of the printer 100 can be reduced.

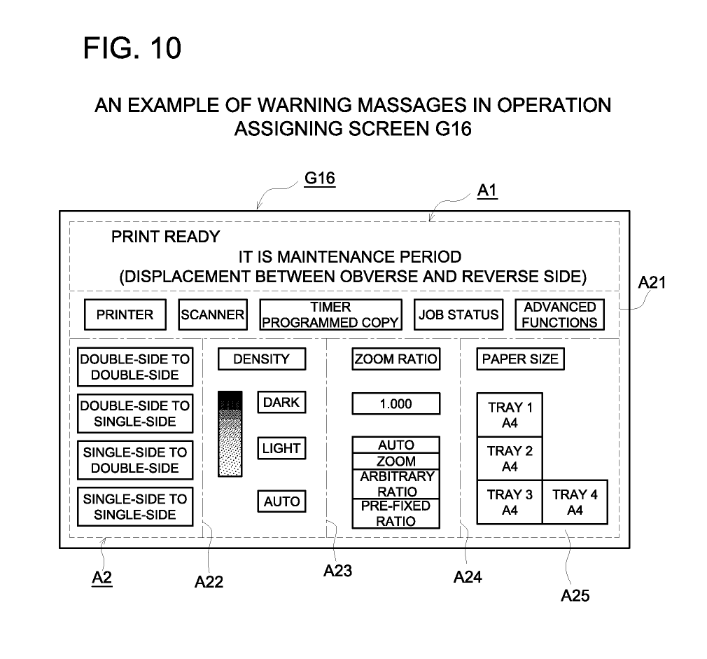

FIG. 10 is a conceptual diagram showing an exemplary warning display in an operation setting screen G16. The operation setting screen G16 is displayed on the display section 16. The operation setting screen G16 is split into a message display area A1 and a condition setting display area A2. In the message display area A1, textual information of “Ready to print” is displayed. Also, when the maintenance period of the printer 100 is due, “Maintenance time (displacement between obverse and reverse surface)” is displayed along with the textual information of “Ready to print”.

On the condition setting display area A2, a function display area A21, a double-side/single side icon display area A22, a density adjusting icon display area A23, a magnification ration adjusting icon display area A24 and a sheet side icon display area A25 are allocated. In the function display area A21, function setting icons such as Printers, “scanner”, “Programmed copy”, “JOB status” and “Advanced functions” are displayed.

Below the function setting icons, in the double-side/single-side icon display area A22, respective mode icons such as “double-side to double side”, “double-side to single-side”, “single-side to double-side”, and “single-side to single-side” are displayed. In the density adjusting icon display area A23, density adjusting icons such as “Density”, “Dark”, “Light and Auto” are displayed. In the magnification ratio adjusting icon display are A24, magnification ratio adjusting icons such as “Magnification ration 1.000”, “Auto”, “Zoom”,

“Arbitral magnification ratio”, “Preset magnification ratio” are displayed. In the sheet size icon display area A25, sheet size icons such as “Tray 1 A4′, “Tray 2 A4”, “Tray 3 A4” and “Tray 4 A4” are displayed.

As above, on the operation setting screen G16 of the display section 16, besides the condition setting display area A2, a massage display area A1 is provided. In the massage display area A1 “Maintenance time (displacement between obverse and reverse surface)” is displayed along with the textual information of “Ready to print” when the maintenance period of the printer 100 is due,”. The user can confirm the maintenance time through the displayed image and the down time for maintenance can be reduced.

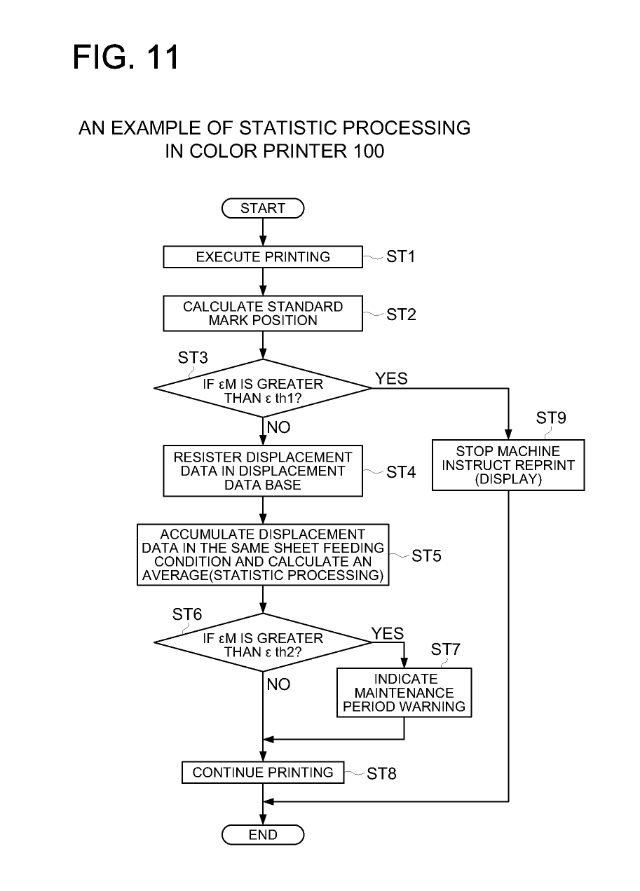

Next, a maintenance management method of the color printer 100 related to the present invention will be described. FIG. 11 is a flow chart showing an exemplary statistical processing of the color printer 100. In this example, the displacements of the obverse and reverse images are accurately detected, and the displacement data, obtained through detection which specializing abnormal displacements, is accumulated and statistically processed. Through this statistical processing, the tendency of the displacement can be understood readily and necessity of the maintenance is predicted before a fatal defect status.

Also, whether or not the position of the image based on the image information is at a predetermined position on the transfer sheet P′ is judged by whether or not the displacement amount ε of the benchmarks Mi is within the tolerance. Then the transition of the displacement amount ε is processed for display respectively for the image forming conditions based on the analysis information obtained through the statistical processing of the displacement data Dε.

In this example, given that the comparison standard value to judge whether or not the displacement amount ε of the benchmarks Mi is within the tolerance is threshold εth1, the displacement amount ε of the transfer sheet P′ and the threshold εth1 are compared and if the displacement amount ε exceeds the threshold εth1, first warning display processing is carried out.

Also, a threshold εth2 smaller than the threshold εth1 is assigned, then the displacement amount ε statistically processed and the threshold εth2 are compared. If the displacement amount ε statistically processed exceeds εth2, second warning display processing to urge the maintenance of the apparatus is carried out. Meanwhile, the threshold εth1 and threshold εth2 are assigned by the user.

With assigning these values to the maintenance management conditions, in the step ST1 of the flow chart shown in FIG. 11, the control section 15 controls the image forming section 80 to carry out a printing process. At this stage, the image forming section 80 forms, for example, an obverse side image “A” and a reverse side image “B” on the predetermined surfaces of the transfer sheet P′ shown in FIG. 2 and FIG. 3 based on the image information in accordance with the double-side to double-side image forming mode as well as the benchmarks M1 to M4 for image position identification at predetermined positions of the transfer sheet P′.

Next, in the step ST 2, the control section 15 calculates positions of the benchmarks Mi (register marks). At this stage, the mark sensors 11 and 12 detect the positions of the benchmarks M1 to M4 with reference to the edge section of the transfer sheet P′ then the mark detection signals S11 and S12 are outputted to the mark image processing section 13. In the mark image processing section 13, the mark detection signals S11 and S12 are binarized and accumulated respectively for one obverse page and for one reverse page. Thereby the displacement data Dε concerning the displacement amount ε of benchmarks M1 to M4 of the transfer sheet P′ can be obtained.

Thereafter, in the step ST3, the control section 15 receives transfer of the displacement data Dε from the mark image processing section 13 and compares the displacement amount ε indicated by the data Dε with a predetermined first threshold εth1 so as to judge whether or not the displacement amount ε is greater that the threshold εth1. If the displacement amount ε is smaller than the threshold εth1, the step ST4 is carried out.

In the step ST4, the control section 15 registers the displacement data Dε in the memory section 30 for the data base. The displacement data Dε obtained by mark image processing section 13 is stored in the memory section 30 for the data base via the control section 15. The displacement data Dε stored in the memory section 30 is used for the statistic processing.

Then, in the step ST5, the control section 15 gathers and averages the displacement data Dε under the uniform image forming (sheet feeding) conditions to obtain an average displacement amount εm (statistical processing). At this stage, the distribution of elements in the displacement amount ε of the benchmarks Mi of the transfer sheet P′ is investigated and the tendency and the characteristic of the displacement amount ε are quantitatively analyzed. For example, the tendency and the characteristic of the displacement amount ε are quantitatively analyzed, respectively for the image forming conditions which include single-side, double-side, sheet size, type of sheet, basis weight, sheet tray and color mode or monochrome mode.

In the step ST6, the control section 15 compares the average displacement amount εm with the second threshold εth2 to judge if the average displacement amount εm is greater than the threshold εth2 or not. In case the average displacement amount εm is greater than the threshold εth2, the control section 15 executes the warning display processing in step ST7 and displays the maintenance time of the printer 100. At this stage, in the massage display area A1 of the operation setting screen G16 shown in FIG. 10, “Maintenance time (displacement between obverse and reverse surface)” is displayed along with the textual information of “Ready to print”.

Also, in case the average displacement amount εm is smaller than the threshold εth2 or after warning display processing is executed, the control section 15 continues the printing processing by the image forming section 80 in step ST8.

Meanwhile, in the step ST3, in case the displacement amount ε is greater than the threshold εth1, the control section 15 controls the display section 16 and the audio output section 18 so as to instruct discontinuing operation of the image forming section 80 and so forth or re-printing processing (first warning display process). The displacement data Dεexceeding the threshold εth1 is omitted from the object of the statistical processing. By this omitting processing, the tendency and the characteristic of the displacement amount ε of the benchmarks Mi, analyzed statistically with time based on the displacement data Dε from which accidentally large displacement is omitted, can be understood.

As above, according to the color printer 100 representing the first exemplary embodiment and the maintenance management, the CPU 55 statistically processes the displacement data Dε memorized and accumulated in the memory section 30. Therefore, the tendency and the characteristic of the displacement amount ε of the benchmarks Mi analyzed statistically with time can be understood.

In the above example, the displacement data Dε, detected by mark sensors 11 and 12 respectively for the image forming conditions including single-side, double-side, sheet size, type of sheet, basis weight, sheet tray and color mode or monochrome mode, is managed so that the transitions of the displacement is displayed respectively for the image forming conditions on the display section 18, thus the transition of displayed amount ε of the benchmarks Mi can be confirmed and positions causing the displacement can be identified readily.

Thereby, the maintenance time of the color printer 100 can be presented by the sound and texture information. Further, the increase of displacement amount ε is informed to the user beforehand without carrying out the maintenance after the performance of the printer 100 has been completely deteriorated, thus occurrence of the down time due to unexpected maintenance can be prevented.

### Exemplary Embodiment

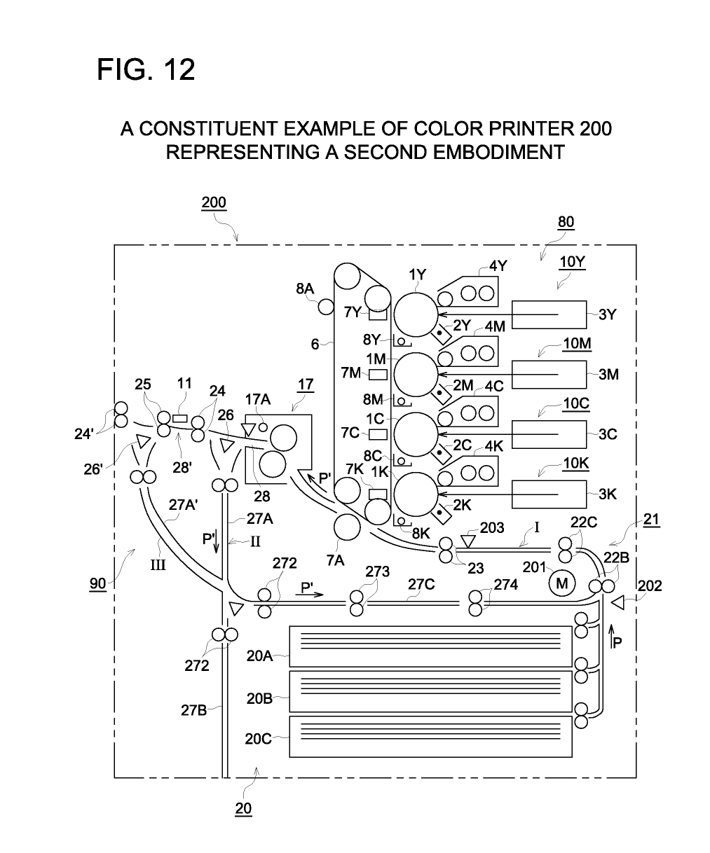

FIG. 12 is a conceptual diagram showing an exemplary configuration of a color printer 200 representing a second exemplary embodiment. In this example, two reversal sheet paths II and III are provided, and the mark sensor 12 for reverse surface is omitted.

A tandem type color printer 200 shown in FIG. 12 configures an example of the image forming apparatus in the same manner as the first exemplary embodiment and has the double-side image forming mode. In this example, the image forming section 80 forms the image based on the image information on a prescribed surface of the sheet P as well as the benchmarks (register marks) for image position identification at prescribed positions on the sheet P. The benchmarks are formed along with the reverse side image at four corners outside the image forming area, and in double-side image forming mode, besides the obverse surface, the benchmarks are formed on the reverse surface along with the reverse side image (refer FIG. 2 and FIG. 3)

On the downstream side of the sheet discharging turn over gate of the fixing unit 17, a transfer sheet turn over section 90′ is provided so as to turn over the transfer sheet P7 where the benchmarks Mi and the obverse side image have been fixed by the fixing unit 17 is turned over. Different from the first exemplary embodiment, in the transfer sheet reversing section 90′ two groups of sheet turn over paths II and III are provide. The sheet turn over path II turns over the transfer sheet P′ in the same manner as the first exemplary embodiment.

The other sheet turn over path III configured with a loop rollers 25, a bifurcation path 26′ and a discharging rollers 24′ operates to turn over the transfer sheet P′ or recording sheet P″ upside down. The loop rollers 25 are located close to the discharging sheet turn over gate 28′ in the figure. The mark sensor 11 for the obverse side image I, located between the sheet discharging rollers 24 of the sheet turnover path II and the loop rollers 25 of the sheet turnover path III, operates to detect the obverse surface of the transfer sheet P′ or the obverse surface and reverse surface of the recording sheet P″ so as to detect the position of the benchmarks Mi. Meanwhile, the components having the same symbols and names as that in the first exemplary embodiment are omitted from the descriptions since they have the same function.

As above, according the color printer 200 representing the second exemplary embodiment, the mark sensor 11 for the obverse side image I, located between the sheet discharging rollers 24 of the sheet turn over path II and the loop rollers 25 of the sheet turn over path III, detects the obverse surface of the transfer sheet P′ or the obverse surface and reverse surface of the recording sheet P″ so as to detect the position of the benchmark Mi. The displacement data Dε obtained from the mark sensor 11 is memorized and accumulated in the memory section 30.

Therefore, in the same manner as the first exemplary embodiment, the CPU 55 statistically processes the displacement data Dε stored and accumulated in the memory section 30. Thereby, in the same manner as the first exemplary embodiment, the tendency and characteristic of the displacement amount ε of the benchmarks analyzed quantitatively with time can be understood.

### Third Exemplary Embodiment

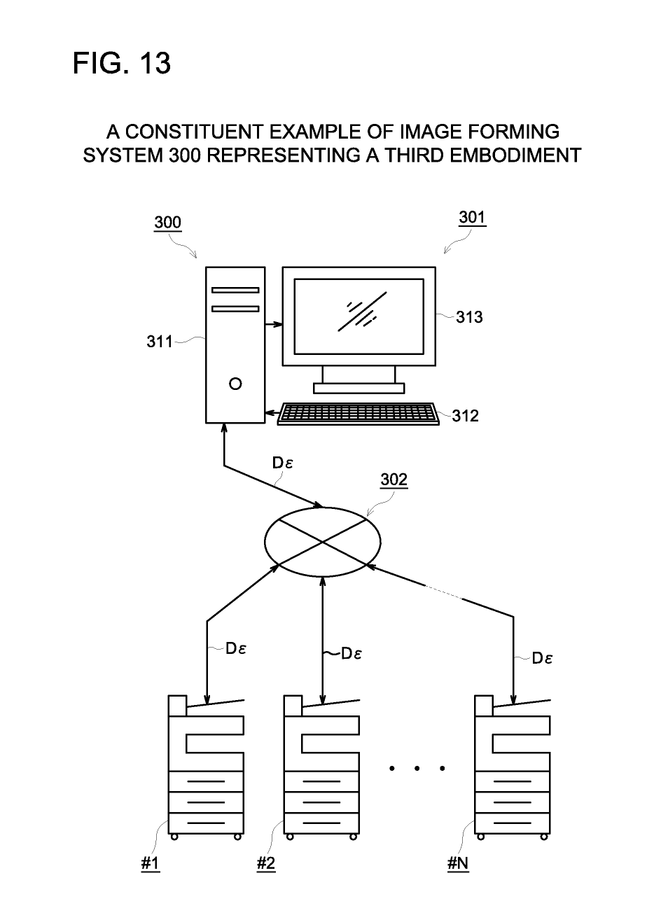

FIG. 13 is a conceptual diagram showing an image forming system 300 representing a third exemplary embodiment. The image forming system 300 shown in the FIG. 13 includes a personal computer (hereinafter called PC 301) configuring an example of the information processing apparatus and one or more color printers capable of communicating with the PC 301 via an communication device 302. As the communication device 302, Internet or local area net work (LAN).

The PC 301 is configured with a control system 311, a key board 312 and a monitor 313. The control system 311 is provided with an unillustrated CPU which realizes the function of the CPU 55 shown in FIG. 4, the Key board 312 having the function of the key board 14 shown in FIG. 4 and the monitor 313 having the function of the display section 16.

For the color printer #1 having a function of the image forming apparatus, the color printers 100 and 200 described in the first and second exemplary embodiments can be applied. For example, the color printer #1 to form the image on the prescribed surface of the transfer sheet P′ based on the image information includes the image forming section 80 to form the benchmarks Mi for identifying the image position at a prescribed position of the transfer sheet P′, mark sensors 11 and 12 to detect the position of the benchmarks Mi formed by the image forming section 80 on the transfer sheet P7 and to output the displacement data Dε, and the memory section 30 to memorize the detected displacement data Dε.

In the example, an unillustrated communication modem is connected with the control section 15, and the CPU 55 transfers the displacement data Dε read from the memory section 30 to PC 301 via communication modem and communication device 302. The PC 301 carries out the statistical processing when the displacement data Dε transferred from the color printer #1 is received. Description of details of the statistical processing is omitted because the statistical processing is configured to enable executing of the function of the CPU 55 described in the first exemplary embodiment.

As above, according to the image forming system 300 representing the third exemplary embodiment, since the color printer 100 related to the present invention and the maintenance and management method thereof can be utilized, by receiving the displacement data Dε from the color printer #1, the distribution of each element in the displacement amount ε of the benchmarks Mi on the transfer sheet P′ is investigated at PC 301 side, and the statistical processing, where the tendency and characteristic of the displacement amount ε is analyzed, can be carried out. Further, the displacement amounts ε of the benchmarks Mi of a plurality of the color printers #1 to #N connected via the communication device 302 such as Internet can be analyzed quantitatively with time in an integrated fashion, and the tendency and the characteristic of the displacement amount ε can be understood collectively.

The embodiments related to the present invention is able from the image based on the image information on the prescribed surface of the transfer material, and is suitable to be applied for the tandem type color printers, the color copying machines and the color combination machines thereof in which the mark images for image position identification are formed at the prescribed positions of the transfer material.

Also according to the above embodiments, the position information obtained by detecting the positions of the mark images formed at prescribed positions on the transfer sheet is statistically processed.

What is claimed is:

1. An image forming apparatus, comprising:
an image forming device to form an image based on image information on a prescribed surface of a transfer material and a mark image for image position identification at a prescribed position on the transfer material;
a detecting device to detect a position of the mark image formed by the image forming device on the transfer material and to output position information;
a memory device to memorize the position information detected by the detecting device; and
a control device to statistically process the position information memorized in the memory device.

2. The image forming apparatus of claim 1, wherein the detecting device is provided at a position, where the transfer material on which the image is formed is discharged, so as to detect the position of the mark image with reference to an edge of the transfer material.

3. The image forming apparatus of claim 1, wherein the detecting device includes a first detecting device to detect the mark image formed by the image forming device on a surface of the transfer material and to output the position information, and a second detecting device to detect the mark image formed by the image forming device on the other surface of the transfer material and to output the position information.

4. The image forming apparatus of claim 1, further comprising a presentation device to present the position information statistically processed and a maintenance time of the image forming device based on the statistical processing, wherein the presentation device includes an audio output section and a display section.

5. The image forming apparatus of claim 1, wherein the control device reads the position information from the memory device, investigates a distribution of each element in a displacement amount of the mark image on the transfer material based on the position information and executes the statistical processing which analyzes tendency and characteristic of the displacement amount quantitatively.

6. The image forming apparatus of claim 1, wherein the control device executes the statistical processing of the displacement amount of the transfer material detected by the detecting device, respectively for image forming conditions which at least include “single-side/double-side”, “sheet size”, “kind of paper”, “basis weight”, “sheet feeding tray”, or “color mode/monochrome mode”.

7. The image forming apparatus of claim 1, wherein being given that a comparison criterion value to judge whether or not the displacement amount of the mark image is within a tolerance is a first threshold, the control device compares the displacement amount detected by the detecting device with the first threshold.

8. The image forming apparatus of claim 7, wherein the control device executes any one of a first warning display process, a machine halt process, or a sheet discharging process in a different sheet discharging condition, if the displacement amount exceeds the first threshold.

9. The image forming apparatus of claim 8, wherein a second threshold smaller than the first threshold is set and the control device compares the displacement amount statistically processed with the second threshold, and executes a second warning display process to urge maintenance of the image forming apparatus when the displacement amount statistically processed exceeds the second threshold.

10. The image forming apparatus of claim 8, wherein the position information exceeding the first threshold is exempt from subjects of the statistical processing.

11. The image forming apparatus of claim 1, wherein the control device executes a display process of a transition of the displacement amount based on analysis information obtained by statistically processing the displacement information.

12. The image forming apparatus of claim 11, wherein the transition of the displacement amount is displayed respectively for image forming conditions.

13. A maintenance management method of an image forming apparatus, comprising:
forming an image based on image information on a prescribed surface of a transfer material and a mark image for image position identification at a prescribed position on the transfer material;
detecting a position of the mark image formed on the transfer material to obtain position information;
storing the position information obtained;
processing the position information stored statistically; and
presenting a maintenance time of the image forming apparatus based on the statistical processing.

14. The maintenance management method of claim 13, wherein the position of the mark image with reference to an edge of the transfer material is detected.

15. The maintenance management method of claim 13, wherein a distribution of each element in a displacement amount of the mark image on the transfer material is investigated and tendency and characteristic of the displacement amount are quantitatively analyzed.

16. The maintenance management method of claim 13, wherein being given that a comparison criterion value, to judge whether or not the displacement amount of the mark image is within a tolerance, is a first threshold, the displacement amount of the transfer sheet is compared with the first threshold.

17. The maintenance management method of claim 16, wherein any one of a first warning display process, a machine halt process, or a sheet discharging process in a different sheet discharging condition is executed, if the displacement amount exceeds the first threshold.

18. The maintenance management method of claim 17, wherein a second threshold smaller than the first threshold is set, and the displacement amount statistically processed is compared with the second threshold, wherein if the displacement amount statistically processed exceeds the second threshold, a second warning display process to urge maintenance of the image forming apparatus is executed.

19. The maintenance management method of claim 16, wherein the position information exceeding the first threshold is exempt from the statistical processing.

20. An image forming system, comprising:
an information processing apparatus;
an image forming apparatus for communication processing with the information processing device via a communication device, including,
an image forming device to form an image based on the image information on a prescribed surface of a transfer material as well as to form a mark image for image position identification at a prescribed position of the transfer material,
a detecting device to detect a position of the mark image formed on the transfer material by the image forming device and to output position information,
a memory device to memorize the position information detected by the detecting device, and
a control device to transfer the position information read from the memory device to the image processing apparatus;
wherein the information processing apparatus receives the position information from the image forming apparatus and executes statistical processing.
